(19) United States
(12) Patent Application Publication
(10) Pub. No.: US 2025/0341985 A1
(43) Pub. Date: Nov. 6, 2025

(54) TARGET AWARE INITIATORS FOR REMOTE STORAGE WHEN TARGET NAMESPACE THROTTLING IS ENABLED

(71) Applicant: Advanced Micro Devices, Inc., Santa Clara, CA (US)

(72) Inventors: Vishwas DANIVAS, Santa Clara, CA (US); Murty Subbaramachandra KOTHA, Santa Clara, CA (US); Mehul Jitendrabhai VORA, Bangalore (IN); Xuyang WANG, Santa Clara, CA (US)

(21) Appl. No.: 18/653,118

(22) Filed: May 2, 2024

(51) Int. Cl. G06F 3/06

(52) U.S. Cl. CPC G06F 3/0659; G06F 3/0604; G06F 3/067

(57) ABSTRACT

Embodiments herein describe an initiator in a remote storage system (e.g., a NIC) that is aware of congestion at the target. In one example, the initiator tracks the number of outstanding requests at a target (e.g., for each namespace). If the target queue is full (i.e., the target cannot handle any more requests), the initiator can move the request from a submission queue (SQ) to a retry queue. Removing the request from the SQ permits the initiator to determine whether the next request in the SQ can be transmitted to its target (e.g., prevents HOLB and also mitigates resource wastage from creating and sending a packet to a full target queue where it will be dropped).

### TECHNICAL FIELD

Examples of the present disclosure generally relate to initiators in a remote storage system that are aware of outstanding requests at a target (e.g., a namespace (NS)).

### BACKGROUND

There are many different remote storage systems where read/write (R/W) requests from a host can be transmitted to remotely distributed hard drives over a network. One such system is Non-Volatile Memory Express (NVME) over Transmission Control Protocol (TCP). NVME over TCP permits a host to use a network interface card or controller (NIC) as an initiator to transmit read and write requests as TCP packets over a network to a remote target. The remote target can include multiple NSs which can logically represent one or more physical hard drives.

However, the target may perform NS throttling where some NSs are fast (are permitted to have a higher data rate) while others are slow (their data rate is limited). When an initiator or host has data to send to both fast and slow NSs, it can experience such problems as head of line blocking (HOLB), resource wastage, and token wastage.

### SUMMARY

One embodiment described herein is an initiator for a remote storage system. The initiator includes a submission queue (SQ) for storing a read/write (R/W) request received from a host to be performed by a remote target, a retry queue configured to store R/W requests corresponding to remote targets that cannot handle more requests, a request tracker configured to track outstanding requests at the remote target, and a packet creator. Moreover, the packet creator includes circuitry configured to upon determining, based on the request tracker, that the remote target cannot handle more R/W requests, move the R/W request from the SQ to the retry queue.

One embodiment described herein is a NIC that includes a SQ for storing a R/W request received from a host to be performed by a remote target, a retry queue configured to store R/W requests corresponding to remote targets that cannot handle more R/W requests, a request tracker configured to track outstanding requests at the remote target, and a packet creator. Moreover, the packet creator includes circuitry configured to upon determining, based on the request tracker, that the remote target cannot handle more R/W requests, move the R/W request from the SQ to the retry queue.

One embodiment described herein is a method that includes retrieving a R/W request from a SQ in an initiator where the R/W request is received from a host to be performed by a remote target and the initiator includes a request tracker that tracks outstanding requests at the remote target, and upon determining, based on the request tracker, that the remote target cannot handle more R/W requests, moving the R/W request from the SQ to a retry queue in the initiator where the retry queue stores R/W requests corresponding to remote targets that cannot handle more R/W requests.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a remote storage system with a target aware initiator, according to an example.

FIG. 2 illustrates a remote storage system with an initiator transmitting data to fast and slow NSs, according to an example.

FIG. 3 is a flowchart for queuing R/W requests in response to tracking congestion at the target, according to an example.

FIG. 4 is a flowchart for scheduling requests in a submission queue and a retry queue, according to an example.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe an initiator in a remote storage system (e.g., a NIC) that is aware of congestion at the remote target. In one example, the initiator tracks the number of outstanding requests at a target (e.g., for each NS). In one embodiment, the NSs may be throttled where some NSs are fast (e.g., permit data speeds of 10 Gbps) while others are slow (e.g., limited to 100 Mbps). The initiator, however, may transmit requests to these NSs in a round-robin manner so that no NS is prioritized over the other. If the current request at the head of the queue is for a slow NS that is currently full, the initiator waits until the NS is free to accept a new request from the initiator, which blocks the other requests in the queue (HOLB). These other requests which may be for fast NSs that are ready to accept and process new requests. Further, having to frequently check to see if a slow NS is now ready to receive the request wastes resources at the initiator. In addition, the initiator may use scheduler tokens when determining whether a request can be spent. If the initiator determines that the slow NS cannot accept the request, the scheduler token is wasted.

In the embodiments herein, the initiator can track the usage of the queues at the remote target. For example, the initiator can know the depth of the target queues (i.e., is target aware), and thus, be able to tell without actually sending a packet to the target whether the target queue is full. If the target queue is full, the initiator can move the request from a submission queue (SQ) to a retry queue. Removing the request from the SQ permits the initiator to determine whether the next request in the SQ can be transmitted to its target NS which prevents HOLB and also mitigates resource wastage from creating and sending a packet to a full target queue where it will be dropped.

Further, the initiator can use a timer or other method to prioritize the request in the SQ over the requests in the retry queue, which will often be associated with slow NSs. For example, the initiator may check to process a request in the SQ once it is ready, but wait until a timer expires (e.g., a 100-300 microsecond timer) before attempting to resend a request in the retry queue. Doing so further mitigates wasting scheduler tokens.

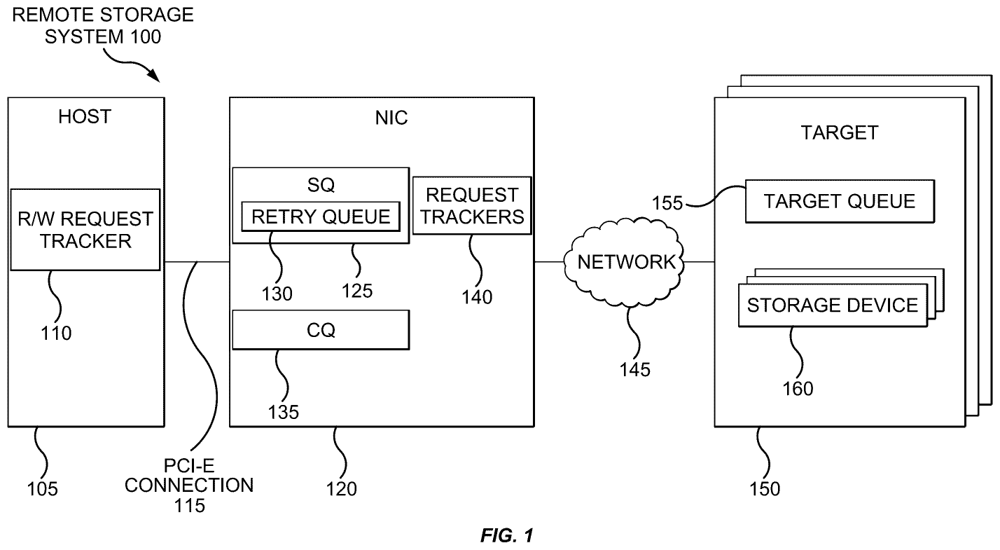

FIG. 1 illustrates a remote storage system 100 with a target aware initiator, according to an example. The remote storage system 100 includes a host 105 (e.g., a server or other computing device), a NIC 120 (e.g., a smartNIC), network 145, and a plurality of targets 150. In one embodiment, the remote storage system 100 is a NVME over TCP system where the host 105 submits read and/or write requests to a NIC 120 that then creates TCP packets containing those requests over the network 145 to the targets 150. While a NVME over TCP system is used to describe various aspects of this disclosure, the embodiments herein are not limited to such and can be applied to other types of remote storage systems 100.

The host 105 can include any number of processors (e.g., central processing units (CPUs) and memory (e.g., volatile memory, non-volatile memory, and combinations thereof). The host 105 includes a R/W request tracker 110 that tracks R/W requests that are sent to the NIC 120 (e.g., an initiator) to be sent to the targets 150. The R/W request tracker 110 can be a queue or buffer. For example, the R/W request tracker 110 may be a queue with a depth of 128 so that the host 105 can have only 128 R/W requests pending to the NIC 120 at any given time.

The host 105 is coupled to the NIC 120 using a PCIe connection 115. For example, the NIC 120 may be disposed on a motherboard in the host. However, the NIC 120 does not have to be disposed in the same form factor as the host 105.

The NIC 120 includes a SQ 125, a completion queue (CQ) 135, and request trackers 140. The SQ 125 receives and stores R/W requests from the host 105. In one embodiment, the SQ 125 is a ring buffer (also referred to as a circular buffer or queue) which is a data structure that uses a single, fixed-size buffer as if it were connected end-to-end.

The SQ 125 also includes a retry queue 130, which can also be implemented as a ring buffer. As discussed in more detail below, when a R/W request in the SQ 125 cannot be sent to its target 150 (e.g., because a target queue 155) is full, the NIC 120 moves the R/W request from the SQ 125 into the retry queue 130. This frees up the SQ 125 so the next R/W request in the SQ 125 can be evaluated to determine whether it can be transmitted to its target 150 (which can be a different target from the request that was moved into the retry queue 130).

In one embodiment, the SQ 125 and the retry queue 130 have the same depth, which may be the maximum number of R/W requests the host 105 can have pending (or outstanding) to the NIC 120. For example, the host 105 may have up to 128 R/W requests pending to the NIC 120. The SQ 125 and the retry queue 130 may be able to store up to 128 requests each. Thus, either the SQ 125 or the retry queue 130 could store all the pending R/W requests. While not a requirement, doing so ensures that the NIC 120 can receive and store the maximum number of requests that might be sent to it from the host 105. Moreover, having the SQ 125 and the retry queue 130 means that there is always room in the retry queue 130 to store the requests for slow NSs, and thus, avoid blocking the SQ 125.

The CQ 135 can store indicators when a R/W request has been completed and the associated data has been read from, or written into, the target 150. The host 105 can then update the R/W request tracker 110 to indicate it can send another R/W request to the NIC 120.

The NIC 120 also includes request trackers 140 which track or monitor the outstanding requests for each of the targets 150. The request trackers 140 can be circuitry (e.g., memory and/or logic), firmware, software, or combinations thereof. The NIC 120 can have a request tracker 140 for each of the targets 150 to monitor how many requests it has sent to that target that have not yet been completed. The request trackers 140 are what make the NIC 120 “target aware” so that the NIC 120 can determine when the target queues 155 are full. In typical remote storage systems, an initiator such as the NIC 120 does not track the number of request that are pending at the targets 150 (i.e., the available capacity of the queues 155 at the targets 150).

The request trackers 140 can be implemented using a variety of different techniques. For example, the NIC 120 may be aware of the depth of the target queues 155, and thus know the maximum number of requests it can send to each target 150. The request tracker 140 can use a consumer index and a producer index where the producer index is incremented each time a request is packetized, sent to, and accepted by, a corresponding target 150. The consumer index is decremented each time a request is completed by the target. The difference between these indexes indicates the number of outstanding requests to the target 150. If that difference matches the depth of the target queue 155, the target queue 155 is full and the target 150 cannot handle any more R/W requests.

In another example, the request tracker 140 can use a counter that is incremented when a request is sent to a target and decremented when a request is completed. When the counter has the same value as the depth of the target queue 155, the NIC 120 knows the queue 155 is full.

The network 145 can be any suitable network and can include a local area network (LAN) or a wide area network (WAN). The network 145 can include private network(s), public network(s), or a combination thereof. In one embodiment, the network 145 supports TCP.

The target 150 includes the target queue 155 which stores the requests received from initiators (e.g., the NIC 120) over the network 145. In one embodiment, the target 150 is a NS, which can include a collection of logical block addresses (LBA) accessible to host software. A namespace ID (NSID) is an identifier used by a controller to provide access to a namespace. A namespace is not the physical isolation of blocks, rather the isolation of logical blocks addressable by the host software.

The target 150 also includes storage devices 160 which can include any type of memory device, and are often non-volatile memory devices (e.g, hard disks, solid-state drives, and the like). A target 150 (such as a NS) can span multiple storage devices 160, or only one storage device 160.

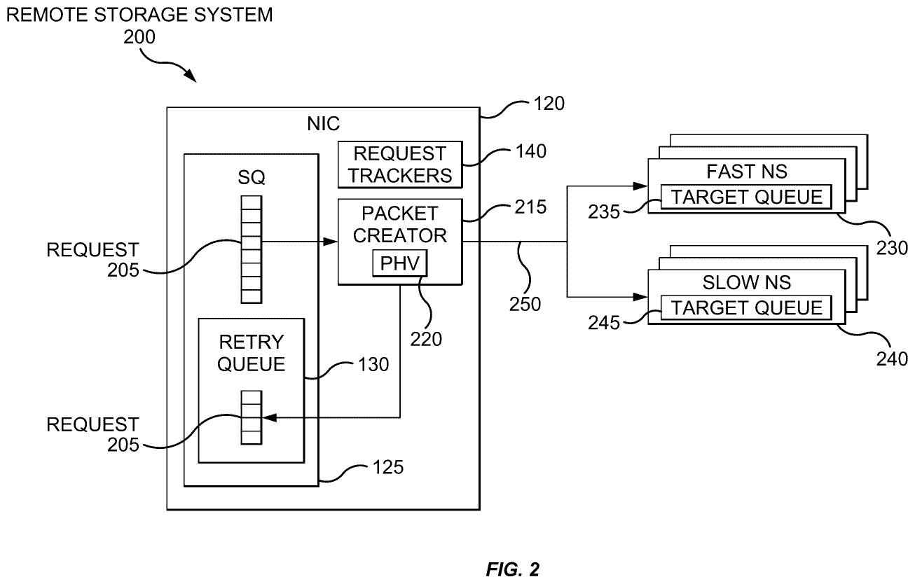

FIG. 2 illustrates a remote storage system 200 with an initiator (e.g., the NIC 120) transmitting data to fast and slow NSs, according to an example. The NIC 120 includes the SQ 125, the retry queue 130 and the request trackers 140 discussed in FIG. 1. In this example, the NIC 120 also includes a packet creator 215 which packetizes the R/W requests received from the host that are stored in the SQ 125 and the retry queue 130.

The packet creator 215 can include hardware, firmware, software, or combinations thereof. In one embodiment, the packet creator 215 is implemented using circuitry (e.g., hardware) since doing so may be faster than using a processor with software or firmware. In one example, the packet creator 215 is a data processing unit (DPU) which is a programmable processor that helps move data around data centers. The DPU can include different types of pipelines for processing received network packets. DPUs can have two types of pipelines: networking pipelines which perform networking tasks such as combining packets that were subdivided to be compatible with a maximum transmission unit (MTU) or for dealing with one or more host operating systems, drivers, and/or message descriptor formats in host memory, and direct memory access (DMA) pipelines which perform memory reads and writes.

Regardless of the specific implementation, the packet creator 215 can receive one of the requests 205 stored in the SQ 125 and determine whether the queue for the NS corresponding to that request 205 is full. For example, the packet creator 215, as part of processing the request, can query the request tracker 140 corresponding to that NS to determine whether the NS can receive or handle any more requests. In other words, the packet creator 215 uses the request trackers 140 to determine whether the target queues 235, 245 for the NSs 230 and 240 are full.

In one embodiment, the packet creator 215 uses a packet header vector (PHV) 220 to process the request and generate the packet for the request. The PHV 220 can contain metadata regarding the request, such as the NS corresponding to the request. Assuming the target queue for the NS is not full, the packet creator converts the PHV 220 into a packet which is then transmitted over the network (as a TCP packet) to the corresponding NS. Although PHVs 220 are specifically shown in FIG. 2, the embodiments are not limited to using PHVs 220 to create packets from the requests 205.

As part of creating packets from the PHVs 220, the packet creator 215 checks to determine whether the target NSs are full using the request trackers 140. If the target queue for the NS has not reached capacity, the packet creator 215 finishes creating the packet and transmits it to the target NS as shown by the arrow 250. However, in this example the target includes a fast NS 230 and a slow NS 240. The fast NS 230 can process more packets (e.g., higher data rates) than the slow NS 240. Put differently, the slow NS 240 may be throttled. Moreover, the target queues 235 and 245 for the NSs 230 and 240 may be the same size (although this is obviously not a requirement). If the NIC 120 has roughly the same amount of traffic to send to both the fast NS 230 and the slow NS 240, then the target queue 245 for the slow NS 240 will fill up faster than the target queue 245 for the fast NS 230. As such, the NIC 120 can quickly find itself in a situation where the R/W requests 205 from the slow NS 240 cannot be sent because its target queue 245 is full while the fast NS 230 can still accept new packet/request because its target queue 235 is not full. Without the embodiments herein, once the target queue 245 for the slow NS 240 is full, the next time the SQ 125 has a request for the slow NS 240, it will create a HOBL where the NIC 120 has to wait until the slow NS 240 has finished another request to create room in its target queue 245. But there may be one (or more) R/W requests in the SQ 125 for the fast NS 230 that is ready now to accept new requests from the NIC 120.

Further still, the packet creator 215 might waste scheduler tokens (which can be used to create the PHVs 220) to keep checking whether the request 205 can be sent to the slow NS 240. As an example, the slow NS 240 may process a request every 300 milliseconds (ms), but the packet creator 215 may be able to convert a PHV 220 into a packet every 30 ms. In the worst case scenario, the packet creator 215 may have created a packet for the request ten times for the same request 205 before that packet is successfully received at the slow NS 240. Before moving on to another request 205 in the SQ 125, the NIC 120 may wait until receiving an acknowledge from the slow NS 240 that the packet was stored in the target queue 245. If not, the NIC 120 assumes it was dropped, and thus, sends the same packet again to the slow NS 240. As such, the NIC 120 may create and send ten packets for the same request 205 before the slow NS 240 has cleared room for the packet so it can be stored in its target queue 245. This waste resources and power in the packet creator 215 for it to create multiple PHVs 220 (and use scheduler tokens) to create packets that are then dropped at the slow NS 240 because its target queue 245 is full.

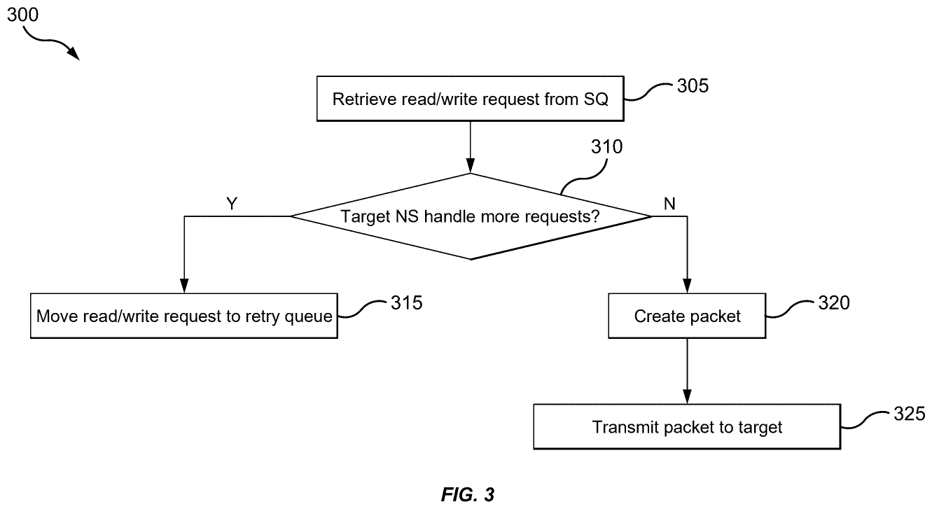

However, in the embodiments herein, because the NIC 120 is target aware, the packet creator 215 can determine before it sends the a packet to the slow NS 240 that its target queue 245 is full by using one of the request trackers 140. If full, the packet creator 215 can drop the PHV 220 for that packet and store the request 205 in the retry queue 130. Since this removes the request from the SQ 125, the packet creator 215 can evaluate the next request in the SQ 125. As such, a request for a slow NS whose target queue is full does not block requests for other NSs whose target queue are not full. This is discussed in more detail in FIG. 3.

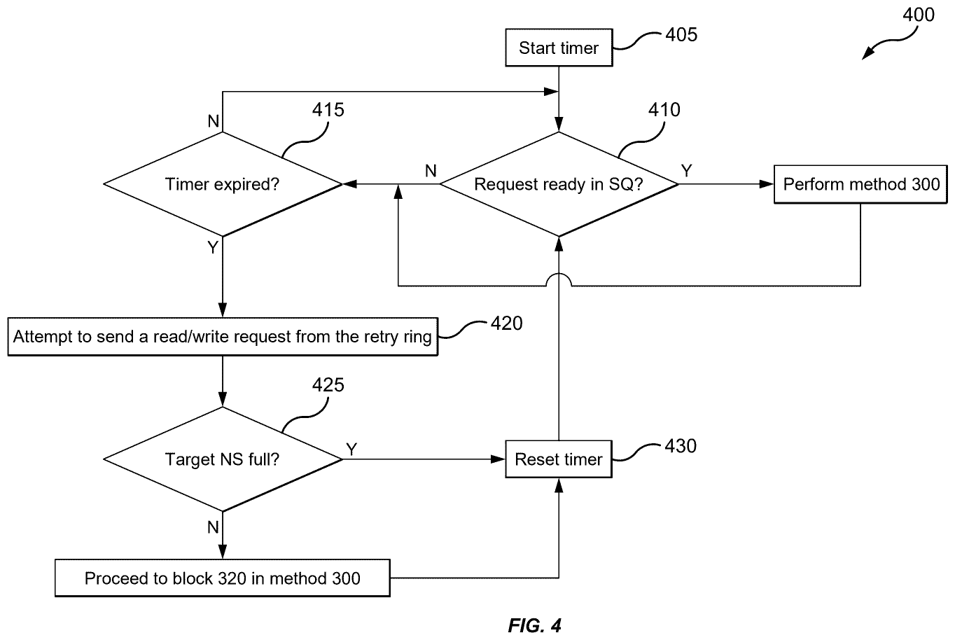

The packet creator 215 can periodically retry to send requests that are stored in the retry queue, but they may be given lower priority than requests that are ready in the SQ 125. For example, the packet creator 215 may constantly attempt to send requests in the SQ 125 but may attempt to send request stored in the retry queue at delayed intervals (e.g., every 300 ms). This is discussed in more detail in FIG. 4.

FIG. 3 is a flowchart of a method 300 for queuing R/W requests in response to tracking congestion at the target, according to an example. At block 305, a packet creator (e.g., the packet creator 215 in FIG. 2) retrieves a R/W request from the SQ in the NIC.

At block 310, the packet creator determines whether the target NS for the R/W request can handle more R/W requests. That is, as part of creating the packet for the request, the packet creator can query a request tracker for the target NS (e.g., the request trackers 140 in FIGS. 1 and 2) to determine whether an input queue for the target NS is full. As mentioned above, the request tracker can track the number of outstanding or pending request at the target NS. Thus, unlike other implementations of NVME over TCP, the initiator (e.g., the NIC) is aware of the target NS's queue depth—i.e., the number of requests the target is currently processing. Moreover, the initiator can independently track the number of outstanding or pending request with each target (e.g., each NS), without having to query the target.

If the target NS cannot handle more requests, the method 300 proceeds to block 315 where the initiator moves the R/W request to the retry queue (e.g., the retry queue 130 in FIG. 1). That way, the R/W request does not block the SQ in the initiator. With the request in a different queue, the initiator is free to evaluate the next ready R/W request in the SQ which might be assigned to a different target NS that does not have a full queue.

If the target NS does not have a full queue (i.e., can handle more R/W requests), the method 300 instead proceeds to block 320 where the packet creator creates a packet. In one embodiment, the packet creator uses a PHV containing metadata about the R/W request to generate the packet. However, this is just one example of packet creation that can be used in the method 300.

At block 325, the initiator transmits the packet to the target NS. For example, the packet may be transmitted on a TCP network to the target.

FIG. 4 is a flowchart of a method 400 for scheduling requests in a submission queue and a retry queue, according to an example. One embodiment, the method 400 begins after the initiator has stored at least one R/W request in the retry queue. For example, the method 400 may start after block 315 in the method 300.

At block 405, the initiator starts a timer. The value of the timer can be adjusted depending any number of variables. In one embodiment, the value of the timer is set based on the speed of the slow NS in the remote storage system. For example, the initiator may know the data rate of the NSs, or the data rate at which they process requests. The initiator can set the timer value to retry packets at a rate that matches (or is slightly longer or slightly shorter) than the rate at which a slow NS processes packets. This can help avoid too frequently checking to determine whether a R/W request in the retry queue can be set, which wastes power and scheduler tokens in the initiator.

At block 410, the initiator determines whether there is a R/W request ready in the SQ. That is, while waiting for the timer to expire, the initiator can continue to process R/W requests in the SQ. In this manner, the requests in the SQ can be prioritized since there might not be a timer associated with those requests, and they can be processed as soon as they are ready.

If there is another R/W request in the SQ, the method 400 returns to the method 300 where the initiator determines whether this request can be sent to its target NS. If so, the initiator generates the packet and sends it. If not, that request is also stored in the retry queue (but the timer would not be reset).

In addition to making the initiator target aware, the remote storage system can also customize the size of the target queues used by the target NSs. Slower NSs can be assigned smaller queues while faster NSs can be assigned larger queues. In this manner, the compute resources at the target can be better allocated between the slower and faster NS (e.g., more memory can be dedicated to the faster NSs since they have faster throughputs).

At block 415, the initiator determines whether the time has expired. If not, the initiator continues to monitor the SQ to determine whether another request should be sent.

Once the time has expired, the method proceeds to block 420 where the initiator attempts to send the R/W request in the retry queue. For example, the request may be the request as the head of the retry queue. If at block 425 the initiator determines the target NS is still full, the method 400 proceeds to block 430 where the timer is reset. Moreover, in one embodiment, in the retry ring, on timer expiry, if the target queue for NS is still full, the request will be re-enqueued to the tail of the retry ring for further retry. This also avoids HOLB of slower NSs in retry ring and makes way for requests of other NSs. The method 400 then returns to block 410 to process requests in the SQ while waiting for the timer to expire.

If the target NS is able to handle more requests, the method 400 instead proceeds to block 320 in method 300 to create and transmit the packet to the target NS. The request can then be removed from the retry queue (e.g., after the target NS acknowledges it received the packet(s) corresponding to the request). The timer can be reset at block 430 (assuming there are more R/W requests stored in the retry queue) and the method 400 can continue to process the request in the SQ at block 410 until the timer expires again.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An initiator for a remote storage system, the initiator comprising:
a submission queue (SQ) for storing a read/write (R/W) request received from a host to be performed by a remote target;
a retry queue configured to store R/W requests corresponding to remote targets that cannot handle more requests;
a request tracker configured to track outstanding requests at the remote target; and
a packet creator comprising circuitry configured to:
upon determining, based on the request tracker, that the remote target cannot handle more R/W requests, move the R/W request from the SQ to the retry queue.

2. The initiator of claim 1, further comprising:
a second request tracker configured to track outstanding requests at a second remote target, wherein the SQ is configured to store a second R/W request to be performed by the second remote target;
the packet creator is further configured to, upon determining, based on the second request tracker, that the second remote target can handle more R/W requests:
create a packet based on the second R/W request; and
transmit the packet to the second remote target using a network.

3. The initiator of claim 2, wherein the network is a Transmission Control Protocol (TCP) network.

4. The initiator of claim 3, wherein the initiator is a network interface card or controller (NIC) configured to perform NVME over TCP to convert R/W requests from the host into packets that are transmitted to the remote targets.

5. The initiator of claim 4, wherein the remote target is a first namespace and the second remote target is a second namespace, wherein the first namespace is throttled relative to the second namespace.

6. The initiator of claim 1, wherein the packet creator is further configured to, after determining that the remote target cannot handle more R/W requests:
start a timer,
continue processing other R/W requests in the SQ while the timer is running, and
attempt to send the R/W request in the retry queue to the remote target after the timer has expired.

7. The initiator of claim 1, wherein the SQ and the retry queue have a same queue depth, wherein the host is configured to not send more R/W requests to the initiator than the queue depth.

8. A NIC comprising:
a SQ for storing a R/W request received from a host to be performed by a remote target;
a retry queue configured to store R/W requests corresponding to remote targets that cannot handle more R/W requests;
a request tracker configured to track outstanding requests at the remote target; and
a packet creator comprising circuitry configured to:
upon determining, based on the request tracker, that the remote target cannot handle more R/W requests, move the R/W request from the SQ to the retry queue.

9. The NIC of claim 8, further comprising:
a second request tracker configured to track outstanding requests at a second remote target, wherein the SQ is configured to store a second R/W request to be performed by the second remote target;
the packet creator is further configured to, upon determining, based on the second request tracker, that the second remote target can handle more R/W requests:
create a packet based on the second R/W request; and
transmit the packet to the second remote target using a network.

10. The NIC of claim 9, wherein the network is a Transmission Control Protocol (TCP) network.

11. The NIC of claim 10, wherein NIC is configured to perform NVME over TCP to convert R/W requests from the host into packets that are transmitted to the remote targets.

12. The NIC of claim 11, wherein the remote target is a first namespace and the second remote target is a second namespace, wherein the first namespace is throttled relative to the second namespace.

13. The NIC of claim 8, wherein the packet creator is further configured to, after determining that the remote target cannot handle more R/W requests:
start a timer,
continue processing other R/W requests in the SQ while the timer is running, and
attempt to send the R/W request in the retry queue to the remote target after the timer has expired.

14. The NIC of claim 8, wherein the SQ and the retry queue have a same queue depth, wherein the host is configured to not send more R/W requests to the NIC than the queue depth.

15. A method comprising:
retrieving a R/W request from a SQ in an initiator, wherein the R/W request is received from a host to be performed by a remote target, wherein the initiator comprises a request tracker that tracks outstanding requests at the remote target; and
upon determining, based on the request tracker, that the remote target cannot handle more R/W requests, moving the R/W request from the SQ to a retry queue in the initiator, wherein the retry queue stores R/W requests corresponding to remote targets that cannot handle more R/W requests.

16. The method of claim 15, further comprising:
retrieving a second R/W request from a SQ in an initiator, wherein the second R/W request is received from the host to be performed by a second remote target, wherein the initiator comprises a second request tracker that tracks outstanding requests at the second remote target; and
upon determining, based on the second request tracker, that the second remote target can handle additional request:
creating a packet based on the second R/W request; and
transmitting the packet to the second remote target using a network.

17. The method of claim 16, wherein the network is a TCP network.

18. The method of claim 17, wherein the initiator is a NIC that performs NVME over TCP to convert R/W requests from the host into packets that are transmitted to the remote target.

19. The method of claim 18, wherein the remote target is a first namespace and the second remote target is a second namespace, wherein the first namespace is throttled relative to the second namespace.

20. The method of claim 15, further comprising, after determining that the remote target cannot handle more R/W requests:
starting a timer,
continuing to processing other R/W requests in the SQ while the timer is running, and
attempting to send the R/W request in the retry queue to the remote target after the timer has expired.
